(19) United States
(12) Patent Application Publication
(10) Pub. No.: US 2023/0175779 A1
(43) Pub. Date: Jun. 8, 2023

(54) SIDE-SUPPORTED CANTILEVER FURNACE ROOF

(71) Applicant: Systems Spray-Cooled, Inc., Smyrna, TN (US)

(72) Inventor: Scott A. FERGUSON, Murfreesboro, TN (US)

(21) Appl. No.: 17/643,354

(22) Filed: Dec. 8, 2021

(51) Int. Cl. F27D 1/02; F27D 1/12

(52) U.S. Cl. CPC F27D 1/021; F27D 1/12

(57) ABSTRACT

Disclosed herein is a metallurgical furnace and roof for the same. The roof has a body. The body has a top surface having a center. The top surface has a center opening disposed about the center. The body has a bottom surface opposite the top surface. An outer sidewall connects the top surface to the bottom surface. The outer sidewall, bottom surface and top surface define an interior portion, wherein the outer sidewall has a lift side and a hood side. An internal spray cooling system is disposed in the interior portion of the body. Lift brackets are disposed on the top surface. The lift brackets are configured to support the entire weight of the roof when suspended by a crane, wherein all the lift brackets are disposed in a first segment of the roof.

### BACKGROUND OF THE DISCLOSURE

### Field of the Disclosure

Embodiments of the present disclosure relates generally to a metallurgical furnace used in the processing of molten materials, the metallurgical furnace having a roof with a spray cooling system. More specifically, the present disclosure relates to a spray cooled metallurgical furnace roof design with side gantry supports.

### Description of the Related Art

Metallurgical furnaces (e.g., an electric arc furnace or a ladle metallurgical furnace) are used in the processing of molten materials. The furnaces house molten materials at least during the heating step when the processing metals. Metallurgical furnaces process such molten materials as steel, which also generate slag as a byproduct of processing.

FIGS. 1A and 1B are schematic diagrams of a metallurgical furnace 150 having a conventional roof 100. The metallurgical furnace 150 has various components, including a hearth that is lined with refractory brick, and a sidewall 124 disposed over the perimeter of the hearth. The hearth and the sidewall 124 define an interior portion of the metallurgical furnace 150. The interior portion may be loaded or charged with material, e.g., metal, scrap metal, or other meltable material, which is to be melted in the metallurgical furnace 150 to form molten material.

The conventional roof 100 has a central opening 102. A delta insert 132 formed of refractory material is fitted in the central opening 102. Electrodes 152 extend from a position above the conventional roof 100 through one or more openings 131 in the delta insert 132. During operation of the furnace 150, the electrodes 152 are lowered through the delta insert 132 into the interior portion of the metallurgical furnace 150 to provide electric arc-generated heat to melt the material. Burners 126, such as fuel feed burners, may be mounted around the sidewalls 124 of the furnace 150 to provide additional heating to cold-spots in the furnace 150 to enhance melting of the material.

The conventional roof 100 includes a vent hole 104 and a roof elbow 144. The roof elbow 144 is fluidly coupled through the vent hole 104 in the conventional roof 100 to the interior portion of the metallurgical furnace 150. The roof elbow 144 directs hot waste gas and air away from the interior portion of the metallurgical furnace 150. The hot waste gas from the metallurgical furnace 150 is directed by the roof elbow 144 for collection by an exhaust evacuation system.

The metallurgical furnace 150 rests on a tilting platform 151 to enable the metallurgical furnace 150 to tilt about an axis. The titling platform include a gantry crane 160 for moving the conventional roof 100 from the metallurgical furnace 150 during non-tilting operations. During the processing of molten materials, the metallurgical furnace 150 tilts in a first direction to remove slag through a first opening in the metallurgical furnace 150 referred to as the slag door. Tilting the metallurgical furnace 150 in the first direction is commonly referred to as “tilting to slag”. The metallurgical furnace 150 also tilts in a second direction during the processing of molten materials to remove liquid steel via a tap spout. Tilting the metallurgical furnace 150 in the second direction is commonly referred to as “tilting to tap”. The second direction is generally in a direction directly opposite the first direction.

The conventional roof 100 is periodically moved from the sidewall 124 of the metallurgical furnace 150 to expose the interior portion of the metallurgical furnace 150. For example, lifting and then swinging the conventional roof 100 horizontally with a gantry crane 160 enables the metallurgical furnace 150 to be loaded or charged with material. The gantry crane 160 has mast arms 162 which spread outward from a mast post for supporting and moving the conventional roof 150. The mast arms 162 extend horizontally across the entire width of the conventional roof 100. The conventional roof 100 has four roof lift members 165 (161-164) attached by chains, cables, or other solid members to the mast arms 162. The mast arms 162 are able to pivot around a point of the mast post for swinging or moving the conventional roof 100 horizontally to the side off and away from the sidewall 124 of the metallurgical furnace 150.

During operation of the metallurgical furnace 150, waste material builds up on the outside and on top of the conventional roof 100. The material has to be cleaned or removed periodically from the top of the conventional roof 100 to prevent weight buildup and stress or failure on the gantry crane 160 and/or lift members 165. Additionally, the refractory delta insert 132 has to periodically be replaced. All this work requires personnel to occasionally go on top of the roof to perform this and other maintenance. However, the mast arms 162 extending entirely across the conventional roof 100 get in the way when removing the delta insert 132 and performing other maintenance. Although there is a platform above the mast arms 162, this platform does not provide the needed access. Therefore, during such operations, the gantry crane 160 may need to be decoupled from the conventional roof 100 and moved out of the way. Additionally, there is very little safe room for a person who is required perform maintenance on the conventional roof 100 and that person must comply with occupational safety hazard regulations and therefore be tethered. All of which adds time and complexity to any maintenance function on the conventional roof 100.

Therefore, there is a need for an improved roof and metallurgical furnace.

### SUMMARY

Disclosed herein is a metallurgical furnace and roof for the same. In one example of a roof, the roof has a body. The body has a top surface having a center. The top surface has a center opening disposed about the center. The body has a bottom surface opposite the top surface. An outer sidewall connects the top surface to the bottom surface. The outer sidewall, bottom surface and top surface define an interior portion, wherein the outer sidewall has a lift side and a hood side. An internal spray cooling system is disposed in the interior portion of the body. Lift brackets are disposed on the top surface. The lift brackets are configured to support the entire weight of the roof when the roof is suspended by a crane. All the lift brackets are disposed in a first segment of the roof.

In another example, a metallurgical furnace is disclosed. The metallurgical furnace has a tilt platform and a gantry crane attached to the tilt platform. The gantry crane has arms. A furnace body is disposed on the tilt platform. The furnace body has a sidewall. The sidewall has a top disposed opposite a bottom, wherein the sidewall surrounds an interior portion of the furnace body. A roof is disposed on the top of the sidewall. The roof has a roof body. The roof body has a top surface having a center. The top surface has a center opening disposed about the center. The roof body additionally has a bottom surface opposite the top surface and an outer sidewall connecting the top surface to the bottom surface. The outer sidewall, the bottom surface and the top surface defining an interior portion. The interior portion is configured to be cooled with a spray cooling system. The outer sidewall has a lift side and a hood side. Lift brackets are disposed on the top surface. The lift brackets are coupled to the arms of the gantry crane and configured to support a weight of the entire roof when the roof is suspended by the gantry crane, wherein all the lift brackets are disposed in a first segment of the roof.

In yet another example, a method of moving a roof from a metallurgical furnace is disclosed. The method begins by attaching a gantry crane to lift points disposed on a first half of the roof closest the gantry crane. The method continues by lifting the roof with the crane by the two lift points wherein the weight of the roof causes a moment about the lift points and directs the roof to contact the gantry crane.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1A and 1B are schematic diagrams of a metallurgical furnace having a conventional roof.

FIG. 2 is schematic top plan view of a new cantilever roof suitable for a metallurgical furnace, such as the metallurgical furnace of FIG. 1A.

FIG. 3 is a schematic side view of the cantilever roof of FIG. 2.

FIG. 4 is a schematic orthogonal top view of the cantilever roof of FIG. 2.

FIG. 5 is another orthogonal top view of the cantilever portion of the cantilever roof of FIG. 3 and FIG. 4.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in the claim(s).

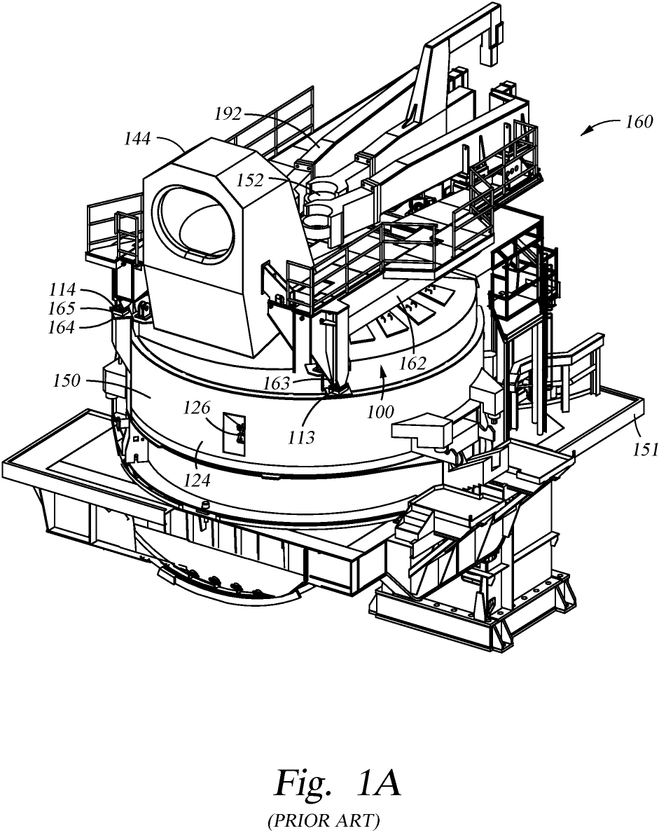

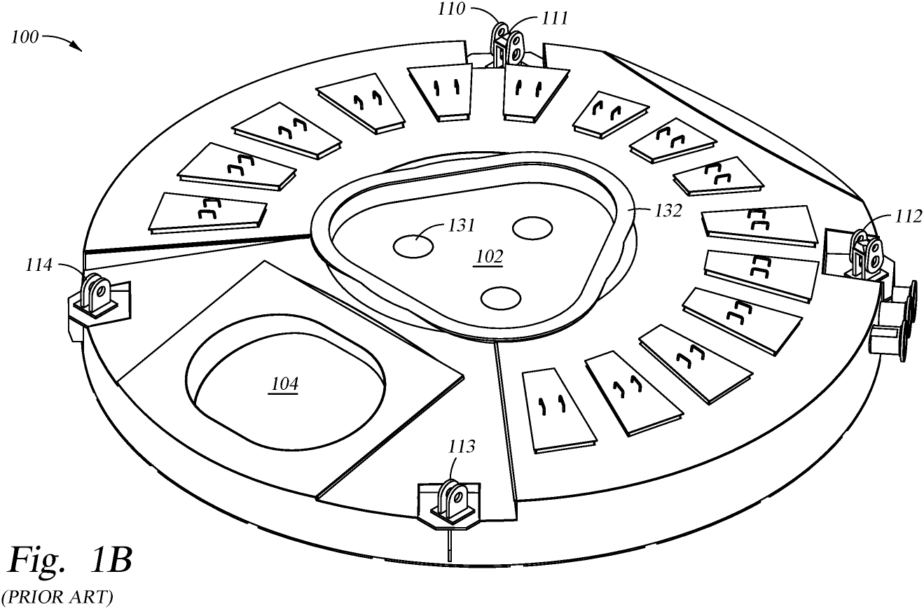

A cantilever roof is disclosed here to replace the conventional roof 100 as disclosed in FIG. 1B above, the conventional roof 100 having traditional long gantry mast arms 162. The cantilever roof has a roof structural design that is stronger than the conventional roof 100. The cantilever roof has short gantry arms which eliminates the space constriction between the top of cantilever roof and the gantry arms, allowing for a taller and better performing steep cone roof design that is better suited for spray-cool cooling. The cantilever roof includes a flat top surface with a full handrail around a perimeter of the top surface of the cantilever roof, which provides a level safer work access platform on top of the cantilever roof. The cantilever roof provides easier access to the top surface, enabling the cantilever roof to be safely and efficiently kept clean of debris, while eliminating weight buildup that undesirably adds stress to gantry lift structure and cylinder. The easily accessible and flat top surface of the cantilever roof enables easier and faster change out of the roof elbow and refractory delta insert, which reduces maintenance costs.

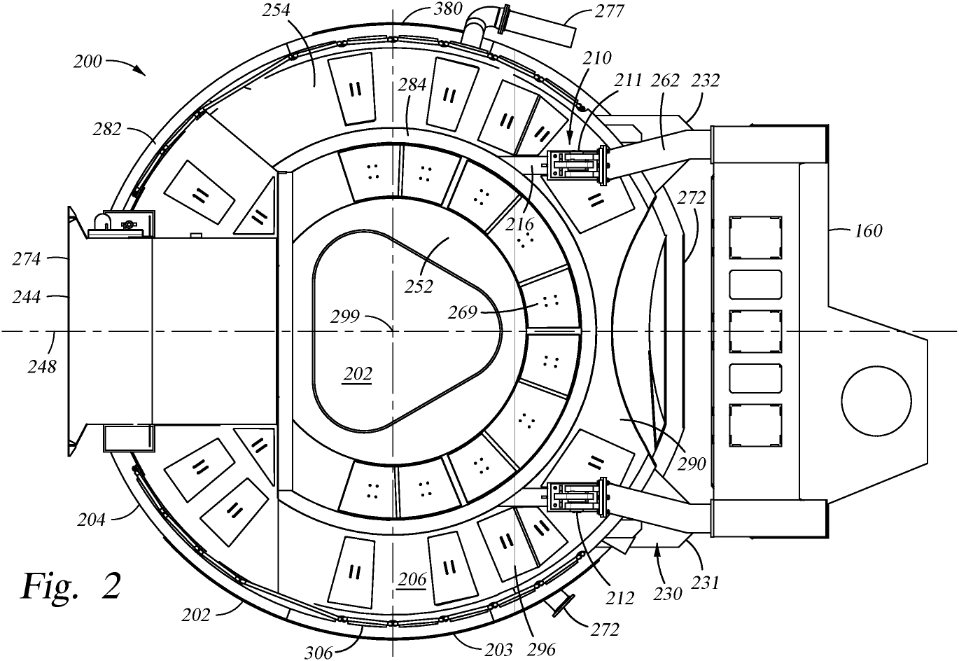

FIG. 2 is schematic top plan view of a cantilever roof 200 that is suitable for use with the metallurgical furnace 150 of FIG. 1A, along with other metallurgical furnaces. Additionally shown with the cantilever roof 200 is the gantry crane 160. The cantilever roof 200 is hollow and includes an internal spray cooling system disposed in an interior portion of the cantilever roof 200. The internal spray cooling system prevents damage to the cantilever roof 200 from the high temperatures of the metallurgical furnace 150. The internal spray cooling system has a fluid feed line 277 and a drain system 278. The fluid feed line 277 provides spray cooling fluid to the internal spray cooling system which sprays the cooling fluid on the interior portion of the cantilever roof 200, thus maintaining the temperature of the roof 200 at or below a desired level. The drain system 278 is configured to remove the spent cooling fluid from the interior portion of the cantilever roof 200.

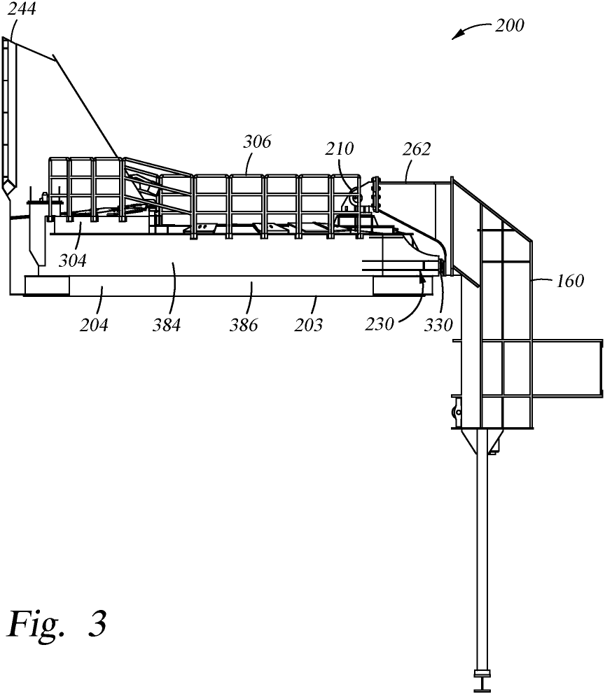

The cantilever roof 200 has a body 202. The body 202 has an outer sidewall 380, a top surface 206 and a bottom surface 203. The bottom surface 203 and the outer sidewall 380 are more clearly shown in FIG. 3. The top surface 206 and the bottom surface 203 are connected together by the outer sidewall 380. A center hole 292 is formed in the body 202 and is bounded by walls extending from the top surface 206 to the bottom surface 203 of the body 202. An interior portion of the body 202 is enclosed by the top surface 206, the bottom surface 203, the outer sidewall 380 and the wall of the center hole 292. The top surface 206 has a plurality of access panels 269 to access the interior portion of the cantilever roof 200. An internal spray cooling system is disposed in the interior portion of the body 202. The internal spray cooling system can be accessed and maintained through the access panels 269.

The body 202 has an outer perimeter 204 along the outer sidewall 380. The body 202 additionally has bracket supports 216 disposed on or through the top surface 206. The body 202 has an outer support ring 282 at the connection of the top surface 206 to the sidewall 380. The body 202 may additionally have an mid ring support 284 disposed on the top surface 206 between the outer support ring 282 and the center hole 292. The outer support ring 282 and mid ring support 284 provides a structural element which is capable of supporting the body 202 along the outer perimeter 204.

The cantilever roof 200 has an orientation which is particular to how the cantilever roof 200, and features of the cantilever roof 200, is oriented with respect the gantry crane 160 and the metallurgical furnace 100. This orientation of the cantilever roof 200 is useful in later discussions. The cantilever roof 200 has a center 299. Along the sidewall 380, the cantilever roof 200 has a crane side 272 and a vent side 274. A first centerline 298 is a diameter which extends from the crane side 272 to the vent side 274 through the center 299. The first centerline 298 is orthogonal to a second diameter, i.e., second centerline 297, at the center 299. As the cantilever roof 200 may not be perfectly round, the second centerline 297 is disposed about half way along the top surface 206 between the crane side 272 and the vent side 274 of the cantilever roof 200. An imaginary chord 296 is orthogonal to the first centerline at a location between the second centerline 297 and the crane side 272 of the cantilever roof 200. In one example, the imaginary chord 296 is about half way between the second centerline 297 and the crane side 272 of the cantilever roof 200. A first segment 290 is formed between from the imaginary chord 296 and the outer perimeter 204 along the crane side 272 of the cantilever roof 200. In one example, the imaginary chord 296 does not intersect the center hole 292. In other examples, the chord 296 passes through the center hole 292. Thus, the first segment 290 of the cantilever roof 200 is the area of the cantilever roof 200 between the crane side 272 and the imaginary chord 296 in a first quarter of a distance along of the first centerline 198 between the crane side 272 and the vent side 274.

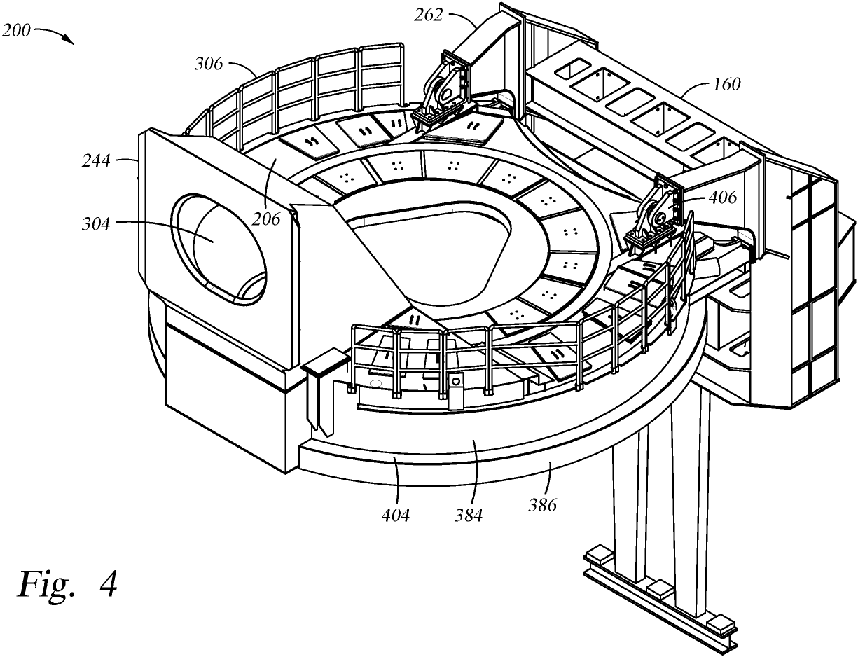

The top surface 206 of the cantilever roof 200 has an outer portion 254 and inner portion 252. The outer portion 254 is disposed between the outer support ring 282 and the mid ring support 284. The inner portion 252 is disposed between the mid ring support 284 and the center hole 292. In one example, the outer portion 254 and/or the inner portion 252 of the top surface 206 is sufficiently flat to provide a safely and level surface for persons working on the roof 200 during maintenance operations. A vent elbow 244 may be disposed through the outer portion 254 and optionally into the inner portion 252 of the top surface. The hot waste gas from the metallurgical furnace 150 is directed out of the furnace 150 through a vent hole 344 (shown in FIG. 3 and FIG. 4) in the roof 200 by the vent elbow 244 for collection by an exhaust evacuation system.

The center hole 292 is configured to accept the delta insert 132. The delta insert 132 is configured to allow the electrode 152 to extend therethrough and into the metallurgical furnace 150. The delta insert 132 (Shown in FIG. 1A) is formed from refractory brick and is routinely replaced in the cantilever roof 200.

The body 202 has bracket supports 216. The bracket supports 216 may be coupled to one or more of the outer support ring 282 and or the mid ring support 284. Alternately, the bracket supports 216 may be coupled at a first end and a second end to the outer support ring 282. It should be appreciated that the bracket supports 216 are structurally integrated into the body 202 such that the two brackets supports 216 can sustain the entire weight of the cantilever roof 200 when the roof 200 is lifted clear of the furnace 150. In one example, the cantilever roof 200 has two bracket supports 216. In another example, the cantilever roof 200 three bracket supports 216. Alternately, the cantilever roof 200 may have one bracket support 216 or four bracket supports 216. However, it should be appreciated that the location for all the bracket supports 216 are between the crane side 272 and the second centerline 297 of the cantilever roof 200.

The cantilever roof 200 is coupled to the gantry crane 160 at one or more lift brackets 210. The lift brackets 210 are disposed on the bracket supports 216 between the center opening and the outer support ring 282, i.e., extends less than halfway across the top surface 206. That is, the lift brackets 210 are disposed within the same portion of the cantilever roof 200 defined between the second centerline 297 and the crane side 272 of the cantilever roof 200. In one example, the cantilever roof 200 has two lift brackets 210 and is coupled to the gantry crane 160 at the two lift brackets 210. In one example, the lift brackets 210 are all in one segment (a region not containing the center bounded by a chord and an arc lying between the chord’s endpoints) of the cantilever roof 200. For example, the lift brackets 210 are disposed in the first segment 290. The first segment 290 containing all the lift brackets 210 are disposed in the first quarter of a roof diameter extending perpendicular to the gantry crane 160. Alternately, all the roof lift points, i.e., lift brackets 210, are disposed between the center hole 292 and the gantry crane 160. It should be noted that no the lift brackets 210 are located between the second centerline 297 and the vent side 274 of the cantilever roof 200.

The cantilever roof 200 is supported by, and movable by, the gantry crane 160. The gantry crane 160 is coupled to the cantilever roof 200 at the two lift brackets 210. This arrangement allows the gantry crane 160 to have short mast arms 262 for coupling to the lift brackets 210. The mast arms 262 are short in that the arms 262 do not extend across the top surface 206 of the cantilever roof 200 opening up the area above the top surface 206. As discussed above with reference to FIGS. 1A and 1B, conventional mast arms extend almost across the entire top surface of conventional roofs. In one example, the gantry crane 160 has two short mast arms 262. In another example, the gantry crane 160 has a number of short mast arms 262 equal to or less than the number of lift brackets 210. However, the cantilever roof 200 does not balanced on the lift brackets 210. To prevent rotation of the cantilever roof 200 about the lift brackets 210, and to keep the cantilever roof 200 oriented with the walls of the metallurgical furnace 150, the cantilever roof 200 has one or more bumpers 230. In one example, the cantilever roof 200 has a pair of bumpers 230, i.e., a first bumper 231 and a second bumper 232. The bumpers 230 are configured to contact, or rest against, the gantry crane 160. In this manner, the lift brackets 210 pivotally support the cantilever roof 200 while the bumpers 230 rest against the gantry crane 160 to prevent to cantilever roof 200 from further rotation and maintain an alignment with the walls of the metallurgical furnace 150. In one example, the bumpers 230 and the lift brackets 210 are all in the one segment 290 of the cantilever roof 200 as described above. The segment 290 containing the lift brackets 210 is disposed in the first quarter portion of the cantilever roof 200 extending from the bumpers 230.

FIG. 3 and FIG. 4 will now be discussed together. FIG. 3 is a schematic side view for the cantilever roof 200 of FIG. 2. FIG. 4 is a schematic orthogonal top view for the cantilever roof of FIG. 2.

The location of the two lift brackets 210 on the cantilever roof 200 permits the replacement of the traditional long gantry lift arms used for lifting the conventional roof/elbow in either 3 or 4 points with short mast arms 262 that only lifts the roof/elbow at the two lift brackets 210. The gantry crane 160 has two short arms 262. The short mast arms 262 extend from the gantry crane 160 to the two lift brackets 210. In one example, the short mast arms 262 do not extend across the center hole 292. In another example, the short mast arms 262 do not extend beyond the first segment 290 of the top surface 206 of the cantilever roof 200. The short mast arms 262 are less costly than conventional longer arms to both replace and maintain arms of the gantry crane 160. The design and orientation of the short mast arms 262 are such that the lift and swing operations of the gantry crane 160 remains unchanged.

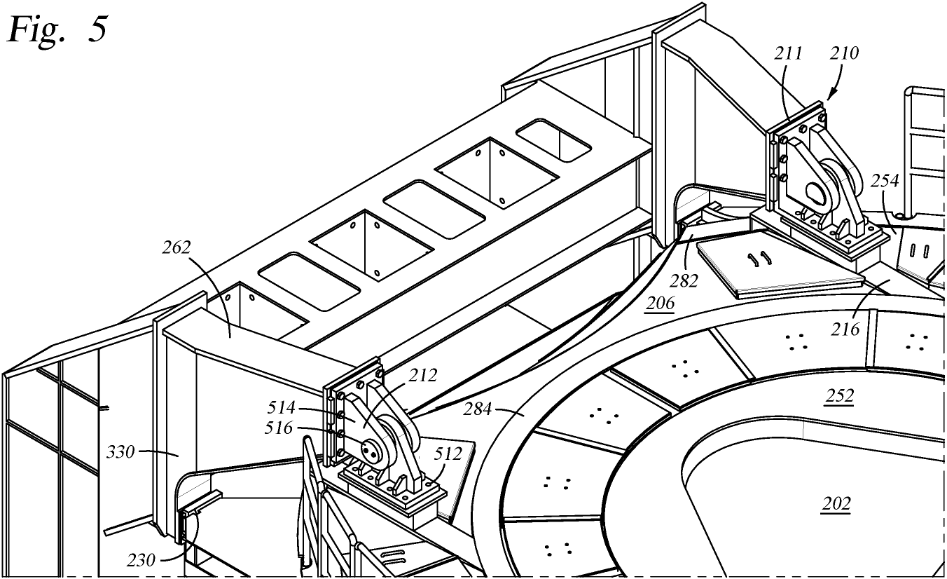

The short mast arms 262 are attached to the two lift brackets 210 by a bracket assembly 400. The bracket assembly 400 is shown in FIG. 5. FIG. 5 illustrates a portion of the orthogonal top view for the cantilever roof 200 of FIG. 3 and FIG. 4. The bracket assembly 400 has design for attaching the two lift brackets 210 to the short gantry arms 262. The bracket assembly 400 is configured to provide a degree of movement between the two lift brackets 210 attached to the short gantry arms 262. The bracket assembly 400 includes an arm bracket 514, a coupling 516, and a roof bracket 512.

The arm bracket 514 is coupled to the short arms 262. The arm bracket 514 may be welded, bolted, formed continuous with, or provided on the short mast arms 262 by any suitable technique providing structural integrity sufficient to support the shear force arising from supporting at least half the weight of the cantilever roof 200. In one example, the arm bracket 514 is fastened by a plurality of bolts to the short arms 262. In another example, the arm bracket 514 is cohesively a part of the short arms 262.

The roof bracket 512 is coupled to the two lift brackets 210 of the cantilever roof 200. The roof bracket 512 may be welded, bolted, formed continuous with, or provided on the two lift brackets 210 by any suitable means providing structural integrity sufficient to support the at least half the weight of the cantilever roof 200. In one example, the roof bracket 512 is fastened by a plurality of bolts to the two lift brackets 210. In another example, the roof bracket 512 is cohesively a part of the two lift brackets 210.

The arm bracket 514 is coupled to the roof bracket 512 by way of the coupling 516. In one example, the arm bracket 514 is hingedly coupled to the roof bracket 512. The coupling 516 is removable from one or both of the arm bracket 514 and the roof bracket 512. The arm bracket 514 and the roof bracket 512 may have a hole or slot configured to accept the coupling 516. In one example, the coupling 516 is pin, bolt, chain, wire or synthetic rope, or other suitable mechanical connection that permits rotational movement between the arm bracket 514 and the roof bracket 512, while mechanically securing the arm bracket 514 and the roof bracket 512 together. For example, the arm bracket 514 and the roof bracket 512 may be coupled together with the coupling 516 to create a hinge.

The bracket assembly 400 allows for additional vertical travel of a lift cylinder so as to not force the cantilever roof 200 down onto the sidewall 124 of the metallurgical furnace 100 when the weight of scrap metal builds up on the top surface 206 of the cantilever roof 200. The design of the roof bracket 512 is a vertical slot that allows the coupling 516 (and short arms 262) to move up/down a certain amount such that when the cantilever roof 200 is lowered onto the sidewall 124 there is still additional stroke in the lift cylinder. Thus, the bracket assembly 400 can freely lower the cantilever roof 200 without bottoming out in the slot and pulling/forcing the cantilever roof 200 down onto the sidewall 124.

The bracket assembly 400 provides a closer connection point for the short mast arms 262 to reduce the moment loading on the gantry crane 160, reducing the wear and tear on the structure and frequency of costly and time-consuming cylinder and bearing or bushing changes.

Returning the FIG. 3 and FIG. 4, the gantry crane 160 additionally has two hard stops 330 configured to align with the bumpers 230 of the cantilever roof 200. Advantageously, eliminating the long gantry arms opens up access to the top of the cantilever roof 200 allows for easier replacement of the refractory delta insert 132, which typically is required every 3-10 days. The short mast arms 262 permit the refractory delta insert 132 to be replaced by only removing the electrodes 152 and without disconnecting the cantilever roof 200 to permit the gantry crane 160 to swing out of way as required in conventional designs, thus reducing downtime and lowering maintenance costs.

The top surface 206 may be sufficiently flat enough to allow a person to safely walk thereon. For example, the top surface 206 may have portions that are between a 0° and 10° pitch for walking thereon. At the outer perimeter 204, a railing 306 is disposed on the top surface 206. The railing 306 is sufficiently high to meet safety requirements such that a person can walk on the top surface of the cantilever roof 200 without wearing a safety harness. The railing 306 helps prevents persons on the top surface 206 from falling off the cantilever roof 200.

The cantilever roof 200 has a sidewall 380. The sidewall 380 is sufficiently high to permit the internal spray cool system, and drain system, disposed in the cantilever roof 200 to efficiently operate and take advantage of gravity. The sidewall 380 has an upper portion 384 and a lower portion 386. The lower portion 386 of a sidewall 380 is disposed along the outer perimeter 204. The lower portion 386 of a sidewall 380 contains the drain system 278. The short mast arms 262 of the gantry crane 160 enable a height of the sidewall 380 to be significantly greater than conventional roofs, thus enabling a larger volume within the roof which aids in the spray cooling and drainage of the cantilever roof 200. That is, short mast arms 262 eliminates the space constriction between the top of cantilever roof 200 and the conventional long gantry arms, thus allowing for a taller and better performing roof.

The cantilever roof 200 eliminates working around long gantry arms and provides an increased measure of safety with the flat top surface and railing 306. The cantilever roof 200 provides a railing 306 encloses the outer perimeter 204 of the cantilever roof 200 creating a safer work access platform. The cantilever roof 200 provides easier access to keep the top of the roof clean of waste material, eliminating weight buildup and added stress on the gantry crane 160. The cantilever roof 200 provides easier access and change out of vent elbow 244 reducing maintenance costs.

In summary, the cantilever roof 200 replaces the traditional long gantry lift arms that lifts the roof/elbow in either 3 or 4 points with short gantry arms that only lifts the roof/elbow at 2 points at the outer edge of the roof. Advantageously, eliminating the long gantry arms opens up access to the top of the cantilever roof for easier refractory delta insert changes, which typically required every 3-10 days, by allowing for the ability to change refractory delta insert by only removing the electrodes and not having to disconnect the roof to swing the gantry out of way, reducing downtime and lowering maintenance costs.

The cantilever roof is stronger than traditional 3 or 4-point lift roofs. However, the cantilever roof short gantry arms eliminates the space constriction between the top of roof and long gantry arms allowing for a taller and better performing steep cone roof. Shorter gantry arms are less costly than longer arms to replace and maintain. The design and orientation of the gantry arms and bearing plates are such that the lift and swing operations of the furnace remain unchanged.

The cantilever roof eliminates working around long gantry arms and provides a measure of safety with the flat roof design and handrail. The cantilever roof allows for a full handrail around the perimeter of roof creating a safer work access platform. The cantilever roof allows for easier access to keep roof clean, eliminating weight buildup and added stress on gantry lift structure and cylinder. The cantilever roof allows for easier access and change out of roof elbow reducing maintenance costs.

\ The closer connection point between the lift bracket and the gantry crane reduces the length of the shorter arms as well as the moment loading on the gantry lift structure. Thus, the shorter arm have the effect of reducing wear and tear on the gantry structure and the frequency of costly and time-consuming repairs to the gantry cylinder, bearing and bushings.

While the foregoing is directed to embodiments of the present disclosure, other and further embodiments may be devised without departing from the basic scope thereof, and the scope thereof is determined by the claims that follow.

What is claimed is:

1. A roof for a metallurgical furnace comprising:
a body comprising:
a top surface having a center, the top surface having a center opening disposed about the center;
a bottom surface opposite the top surface; and
an outer sidewall connecting the top surface to the bottom surface, the outer sidewall, the bottom surface and the top surface defining an interior portion, wherein the outer sidewall has a lift side and a hood side;
an internal spray cooling system disposed in the interior portion of the body;
lift brackets disposed on the top surface, the lift brackets configured to support a weight of the entire roof when the roof is suspended by a crane, wherein all the lift brackets are disposed in a first segment of the roof.

2. The roof of claim 1, wherein the first segment containing the lift brackets is disposed in a first quarter of a roof diameter extending from the lift side.

3. The roof of claim 1 further comprising:
bumpers disposed on the lift side of the outer sidewall, wherein the bumpers are in the first segment of the roof.

4. The roof of claim 1 further comprising:
a first centerline extending through the center from the lift side to the hood side; and
a second centerline extending through the center and orthogonal to the first centerline, wherein no lift points are disposed between the second centerline and the hood side.

5. The roof of claim 1 further comprising:
a safety railing disposed on the top surface along an outer perimeter of the top surface.

6. The roof of claim 1 further comprising:
a vent hood defining a vent side of the body, wherein the vent hood is disposed through the top surface and the bottom surface, the vent hood configured to fluidly couple an interior portion of a metallurgical furnace to an exhaust evacuation system.

7. A metallurgical furnace comprising:
a tilt platform;
a gantry crane attached to the tilt platform, the gantry crane having arms;
a furnace body disposed on the tilt platform, the furnace body comprising:
a sidewall, the sidewall having a top disposed opposite a bottom, wherein the sidewall surrounds an interior portion of the furnace body;
a roof disposed on the top of the sidewall, the roof comprising:
a roof body comprising:
a top surface having a center, the top surface having a center opening disposed about the center;
a bottom surface opposite the top surface; and
an outer sidewall connecting the top surface to the bottom surface, the outer sidewall, the bottom surface and the top surface defining an interior portion, the interior portion configured to be cooled with a spray cooling system, and wherein the outer sidewall has a lift side and a hood side; and
lift brackets disposed on the top surface, the lift brackets coupled to the arms of the gantry crane and configured to support a weight of the entire roof when the roof is suspended by the gantry crane, wherein all the lift brackets are disposed in a first segment of the roof.

8. The metallurgical furnace of claim 7 wherein the roof has no more than two lift brackets.

9. The metallurgical furnace of claim 8 wherein the roof further comprises:
a first centerline extending through the center from the lift side to the hood side; and
a second centerline extending through the center and orthogonal to the first centerline, wherein no lift points are disposed between the second centerline and the hood side.

10. The metallurgical furnace of claim 9 wherein a length of the arms for the gantry crane extend short of the second centerline.

11. The metallurgical furnace of claim 9, wherein the first segment containing the lift brackets is disposed in a first quarter of a roof extending from the lift side.

12. The metallurgical furnace of claim 11, wherein a length of the arms for the gantry crane do not extend beyond the first segment.

13. The metallurgical furnace of claim 9, wherein the roof further comprises:
bumpers disposed on the lift side of the outer sidewall, wherein the bumpers are in the first segment of the roof and are configured to contact the gantry crane when the gantry crane is supporting the weight of the roof.

14. The metallurgical furnace of claim 13, further comprising:
a vent hood defining a vent side of the roof, wherein the vent hood is disposed through the top surface and a bottom surface and configured to fluidly couple the interior portion of the metallurgical furnace to an exhaust evacuation system.

15. The metallurgical furnace of claim 9, wherein the roof further comprises:
a safety railing disposed on the top surface along an outer perimeter of the top surface.

16. The metallurgical furnace of claim 9, wherein the arm of the gantry crane is attached to the lift bracket by a slotted pin.

17. A method of moving a roof from a metallurgical furnace, comprising:
attaching a gantry crane to lift points disposed on a first half of the roof closest the gantry crane; and
lifting the roof with the crane by the two lift points wherein the weight of the roof causes a moment about the lift points and directs the roof to contact the gantry crane.

18. The method of claim 17 wherein the roof only has two lift points.

19. The method of claim 18 wherein the two lift points are disposed in a segment of the roof in the first quarter of the roof from the gantry crane.

20. The method of claim 17 wherein the two lift points are pinned to two arms of the gantry crane.
